(19) United States
(12) Patent Application Publication
(10) Pub. No.: US 2015/0310481 A1
(43) Pub. Date: Oct. 29, 2015

(54) SYSTEM AND METHOD FOR MANAGEMENT OF MARKETING CAMPAIGNS

(71) Applicant: Go Daddy Operating Company, LLC, Scottsdale, AZ (US)

(72) Inventors: Bill Brown, Phoenix, AZ (US); Judd Jacobs, San Jose, CA (US); Ian Schiffer, Scottsdale, AZ (US); Richard Uhl, Phoenix, AZ (US)

(73) Assignee: Go Daddy Operating Company, LLC, Scottsdale, AZ (US)

(21) Appl. No.: 14/261,178

(22) Filed: Apr. 24, 2014

(51) Int. Cl. G06Q 30/02

(52) U.S. Cl. CPC G06Q 30/0243

(57) ABSTRACT

A system and method for automatically assigning marketing allocations, including advertisements and coupons, for a business to marketing channels. An investment engine and recommendation engine uses input data to assign marketing allocations to marketing channels. Consumer activity is generated that produces corresponding output data. The investment engine calculates a return-on-investment (ROI) metric, and the recommendation engine generates a report related to the input and output data. The input data, marketing allocations or channels are adjusted to optimize the ROI metric and recommend marketing campaign strategies. The system also automatically determines which keywords the business should assign their marketing allocations to when a consumer utilizes similar keywords on a search engine. Targeted keywords are determined by applying budget weights to keywords related to the business and monitoring output data, such as a click through rate of the marketing allocations. Keywords with higher click through rates receive higher budget weights.

### CROSS-REFERENCE TO RELATED APPLICATIONS

N/A

### BACKGROUND OF THE INVENTION

The present invention relates to systems and methods for managing marketing allocations for a business, both online and offline marketing. More particularly, the invention relates to systems and methods for automatically assigning and recommending marketing allocations to marketing channels for a business to optimize profitability, automate search engine optimization (SEO) strategies, and optimize marketing campaigns.

Recently, online advertising has become an important marketing channel for companies selling various goods and services. In the typical online advertising scenario, a user receives content and is presented with an advertisement, such as a banner ad, skyscraper ad, pop-up ad, pushed advertisements or in-content ad, served to a ever-widening range of devices, both mobile and non-mobile.

Various systems have been developed to distribute advertisements to users. A common example is a user requesting content over a network, such as the Internet, in the form of a web page or web resource and receiving the content with advertisements included. Another example is an advertiser may directly transmit advertisements to a destination website for presentation to users.

Increasingly, however, advertisers are choosing to indirectly distribute their advertisements through online advertising agencies and advertising services. Online advertising agencies are typically intermediaries that redistribute advertisements to advertising services. Advertising services are typically entities that store advertisements from multiple sources and distribute the stored advertisements to a network of destination websites. In operation, an online advertising agency may receive advertisements from a business and subsequently distribute the advertisements to several different advertising platform services. As a result, a single advertisement may be passed downstream several times prior to reaching an advertising service.

While the aforementioned distribution scheme allows advertisements to quickly reach a wide audience, it is difficult to determine which marketing channels to distribute marketing allocations, such as advertisements and coupons, to that will optimize profitability for the business. Thus, it can be difficult to accurately assess the effectiveness of any particular component of a multi-facetted marketing plan. As previously stated, many companies engage in advertising through multiple marketing channels, such as TV, radio, Internet, and the like, to improve their bottom line. However, it is difficult for these companies, especially small businesses, to correlate advertising and marketing expenditures across many different channels with profits. Furthermore, it is difficult to ascertain how to allocate a marketing budget among different types of marketing channels to maximize sales, let alone a return on investment.

Companies are asking their marketing leadership for a more direct accounting of the marketing department's performance in terms of marketing investment and the effectiveness and efficiency of marketing operations. Given the challenges in correlating investment in multichannel marketing campaigns with sales, companies may be finding it difficult to determine how best to adjust marketing investments to maximize sales. In addition, small businesses do not always have access to marketing leadership experts. Thus, for small businesses, analyzing performance in terms of marketing investment and determining which marketing channels to allocate a marketing budget to remains a significant obstacle to improving marketing efficiency and acquiring new customers.

One marketing channel that has become increasingly popular for businesses to launch their ad campaigns on are search engines, such as GOOGLE®, YAHOO!®, BAIDU®, and BING®. These search engines' most lucrative publicity channels is the sponsored search network, where advertiser text ads are shown on the result pages of user search queries. Sponsored search advertising typically allows the advertisers to target specific audiences by choosing exactly which keywords they wish to associate with their products or services, as well as which geographic locations they want to consider. When the keywords forming a campaign are carefully selected, ads are mostly shown to users who represent real potential customers and are truly interested in the product or service offered. In addition, sponsored search campaigns are accessible to all types of businesses because advertisers have the liberty of deciding exactly how much they are willing to pay for each click by a user on the advertisement.

For example, large businesses with high profit margins might be willing to pay more for each click, whereas smaller businesses with lower profit margins may not be able to pay as much for each click, and therefore are not benefiting as much as larger businesses. Additionally, larger businesses may have marketing budgets that allow them to bid on all the keywords they judge to be relevant to their business with multiple combinations of verbs, adjectives, and nouns, as well as many misspellings and singular/plural forms that might be possible. Therefore, campaign portfolios can contain incredibly high numbers of keywords and can be incredibly expensive. As a result, small businesses have shied away from search engine marketing because of their limited resources for identifying which keywords to bid on, how much to bid on each keyword, and how to monitor the success metrics associated with the keywords in order to optimize profitability.

In addition, while some companies know which marketing channel to launch marketing campaigns on in order to optimize profitability, many businesses, both large and small, are often uncertain about what content to include in their marketing campaign. Determining what advertisement to send, what content to include in the message, and when to send the advertisement to consumers is another significant obstacle to improving marketing efficiency and acquiring new customers. Often times, businesses, especially small businesses, focus their time on the core business and do not have time to effectively market. Small business owners are typically experts in their respective field, and not experts in marketing. Thus, some business owners may be using ineffective marketing techniques, such as asking other business owners what their marketing techniques are, which may not generate effective marketing results.

### SUMMARY OF THE INVENTION

The present invention overcomes the aforementioned drawbacks by providing a system and method for automatically assigning and recommending customized marketing allocations, including advertisements and coupons, for a business to marketing channels while dynamically controlling such allocations, for example, based on the particular business' return on investment when using each of the marketing channels. Business input data is used by an investment engine and a recommendation engine to assign and recommend marketing allocations to marketing channels, such as search engines and social media networks. Thus, consumer activity is generated that produces corresponding output data. The investment engine calculates a return-on-investment (ROI) metric, and the recommendation engine generates a report related to the input and output data, and adjusts the input data, marketing allocations or channels to improve the ROI metric and recommend marketing campaign strategies. The system is also capable of automatically determining which keywords the business should assign their marketing allocations to when a consumer utilizes similar keywords on a search engine. The targeted keywords are determined by applying budget weights to keywords related to the business and monitoring output data related, but not limited, to a click through rate of the marketing allocations or post-lick activity including whether the customer converts to a sale. Thus, keywords with higher click through rates receive a higher budget weight, and keywords with lower click through rates receive a lower budget weight or are removed from the targeted keywords.

In accordance with one aspect of the invention, a system for automatically assigning marketing allocations for a business to one or more marketing channels is disclosed. The system includes a non-transitory, computer-readable storage medium having stored there on input data configured to be analyzed by an investment engine. The system also includes a processor configured to receive the input data and access the non-transitory, computer-readable storage medium to execute the investment engine. The investment engine may then assign the marketing allocations to one or more of the marketing channels based on the input data to generate consumer activity. Output data related to the consumer activity with respect to the business is then received by the investment engine. A return-on-investment (ROI) metric for the business is calculated related to the input data and the output data and compared to a predetermined threshold value. The input data, the marketing allocations, or the marketing channels are then adjusted to raise the ROI metric toward the predetermined threshold value. The above described is repeated until the ROI metric is above the predetermined threshold value.

In accordance with another aspect of the invention, a method for automatically assigning marketing allocations for a business to at least one marketing channel is disclosed. The method includes providing input data configured to be analyzed by an investment engine and assigning the marketing allocations to the at least one marketing channel based on the input data to generate consumer activity. Output data related to the consumer activity with respect to the business is then received by the investment engine and a return-on-investment (ROI) metric is calculated for the business related to the input data and the output data. The ROI metric is then compared to a predetermined threshold value. The input data, the marketing allocations, or the at least one marketing channel are adjusted to raise the ROI metric toward the predetermined threshold value. The above steps are repeated until the ROI metric is above the predetermined threshold value.

In accordance with another aspect of the invention, a method for automatically determining a plurality of search keywords that activate marketing allocations for a business on a search engine interface is disclosed. The method includes providing input data related to the business that is configured to be evaluated by an algorithm. The plurality of search keywords are then generated that correspond to the input data. The marketing allocations for the business are displayed to one or more users on the search engine interface when the user enters search terms into the search engine interface that are substantially the same as at least one of the plurality of search keywords. Output data related to the marketing allocations is received as consumers manipulate the search engine interface, and a rating value is assigned to each of the plurality of search keywords based on the output data. The rating value is then compared to a predetermined threshold value. Using the algorithm, the input data, the marketing allocations, or at least one of the plurality of search keywords are adjusted to raise the rating value towards the predetermined threshold value. The above steps are repeated until the rating value is above the predetermined threshold value.

In accordance with another aspect of the invention, a system for automatically analyzing current marketing practices and generating marketing campaign recommendations for a business is disclosed. The system includes a non-transitory, computer-readable storage medium having stored there on input data configured to be analyzed by a recommendation engine. The system also includes a processor configured to receive the input data and access the non-transitory, computer-readable storage medium to execute the recommendation engine. The recommendation engine may then assign the marketing campaign recommendations to one or more marketing channels based on the input data, and launch the marketing campaign recommendations on one or more marketing channels. The recommendation engine then receives the output data related to the one or more marketing campaign recommendations as consumers are exposed to the one or more marketing campaign recommendations. A performance metric is calculated for the business related to the one or more marketing campaign recommendations and compared to a predetermined threshold value. At least one of the input data, marketing campaign recommendations, or the marketing channels is adjusted to raise the performance metric toward the predetermined threshold value. The above steps are then repeated until the performance metric is above the predetermined threshold value.

In accordance with another aspect of the invention, a method for automatically analyzing current marketing practices and generating marketing campaign recommendations for a business is disclosed. The method includes providing input data configured to be analyzed by a recommendation engine and assigning the marketing campaign recommendations to one or more marketing channels based on the input data. The method further includes launching one or more of the marketing campaign recommendations on the marketing channels. Output data related to the one or more marketing campaign recommendations is received as consumers are exposed to the one or more marketing campaign recommendations. A performance metric is then calculated for the business related to the one or more marketing campaign recommendations. The performance metric is compared to a predetermined threshold value, and at least one of the input data, marketing campaign recommendations, or the marketing channels is adjusted to raise the performance metric toward the predetermined threshold value. The above steps are repeated until the performance metric is above the predetermined threshold value.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a schematic view of an environment in which an embodiment of the invention may operate.

FIG. 2 is a flow chart setting forth the steps of processes for assigning marketing allocations for a business to marketing channels.

FIG. 3 is a flow chart setting forth the steps of processes for determining search keywords that activate marketing allocations for a business on a search engine interface.

FIG. 4 shows a representation of an example image of input data for a business.

FIG. 5 is a schematic view of an environment in which another embodiment of the invention may operate.

FIG. 6 is a flow chart setting forth the steps of processes for analyzing current marketing practices and generating customized marketing campaigns for a business.

FIG. 7 shows a representation of an example sign-up form utilized by customers of the business to receive the marketing campaign.

FIG. 8 shows a representation of an example user interface displaying customer data and recommendations related to the marketing campaign.

FIG. 9 shows a representation of an example user interface displaying recommendations for a business new to launching a marketing campaign.

FIG. 10 shows a representation of an example customized coupon automatically generated for the business to launch as a marketing campaign.

FIG. 11 shows a representation of an example report generated after launching the marketing campaign.

FIG. 12 shows a representation of another example report generated after launching the marketing campaign and displaying customer related data and marketing campaign recommendations for the business.

FIG. 13 shows a representation of an example report generated related to a specific customer of the business.

### DETAILED DESCRIPTION OF THE INVENTION

This description primarily discusses illustrative embodiments as being implemented in conjunction businesses, such as restaurants. It should be noted, however, that discussion of restaurants and restaurant menus simply is one example of many different types of businesses and their business offerings that apply to illustrative embodiments. For example, various embodiments may apply to businesses, such as department stores, salons, health clubs, supermarkets, banks, movie theaters, ticket agencies, pharmacies, taxis, and service providers, among other things. Accordingly, discussion of restaurants is not intended to limit various embodiments of the invention.

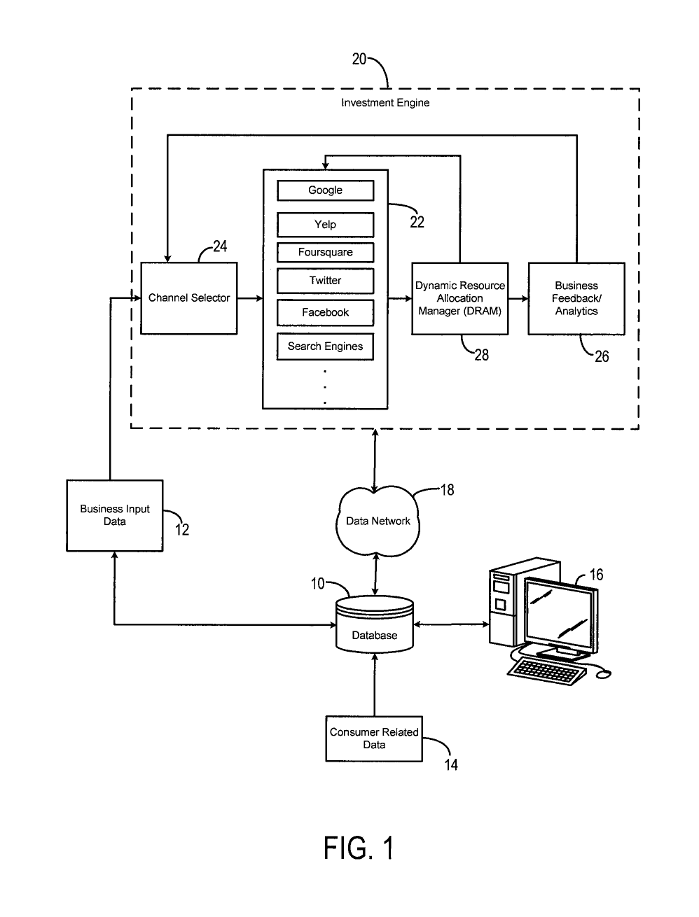

Referring now to FIG. 1 a schematic view of an environment in which the invention may operate is shown. The environment includes one or more remote content sources 10, such as a database or non-transitory, computer-readable storage medium on which business input data 12 and consumer related data 14 corresponding to a business are stored. A processor 16 may be configured to access the remote content source 10 to store market data, for example, related to the business input data 12 and consumer related data 14. The remote content source 10 is connected, via a data communication network 18 such as the Internet, to an investment engine 20 in accordance with an embodiment of the invention.

As described in more detail below, the investment engine 20 may be configured to receive the input data 12 and consumer related data 14 to determine which marketing channels 22, such as search engines or social media networks, for example, the business should spend their marketing budget on in order to improve profitability. As will be further described, the business input data 12 may include, but is not limited to, the business type, age of the business, business location, business offerings, a marketing budget, business's preferences, target demographic information, sales feedback data, and the like. The consumer related data 14 may include, but is not limited to credit card data, search engine data, customer feedback, sales feedback, market spend by consumers, actual spend, and the like. Both the business input data 12 and the consumer related data 14 may be aggregated. Thus, in the following description of uses for the business input data 12 and the consumer related data 14, the systems and methods may use business input data 12 and consumer related data 14 for a particular business or for an aggregation of businesses. That is, the business input data 12 and consumer related data 14 may be compiled from the aggregated performance/ROI of all marketing campaign sent through these systems and methods, such through a feedback loop. When combined with customer demographics, for example, for cluster analysis, the following recommendations will become more predictive over time.

The investment engine 20 may include a channel selector 24 that chooses, based upon, but not limited to the business input data 12, the consumer related data 14 and, as will be described, feedback from the business 26, which marketing channels 22 to distribute the business's marketing allocations (i.e., advertisements, coupons, and the like) according to the business's marketing budget. A dynamic resource allocation manager (DRAM) 28 may be configured to receive consumer related data 14 that corresponds to the consumer activity generated on the targeted marketing channels 22 and calculate a return-on-investment (ROI) metric. Based on the ROI metric, the investment engine 20 may adjust the marketing allocations and/or marketing channels 22 to improve the business's performance relative to the ROI metric.

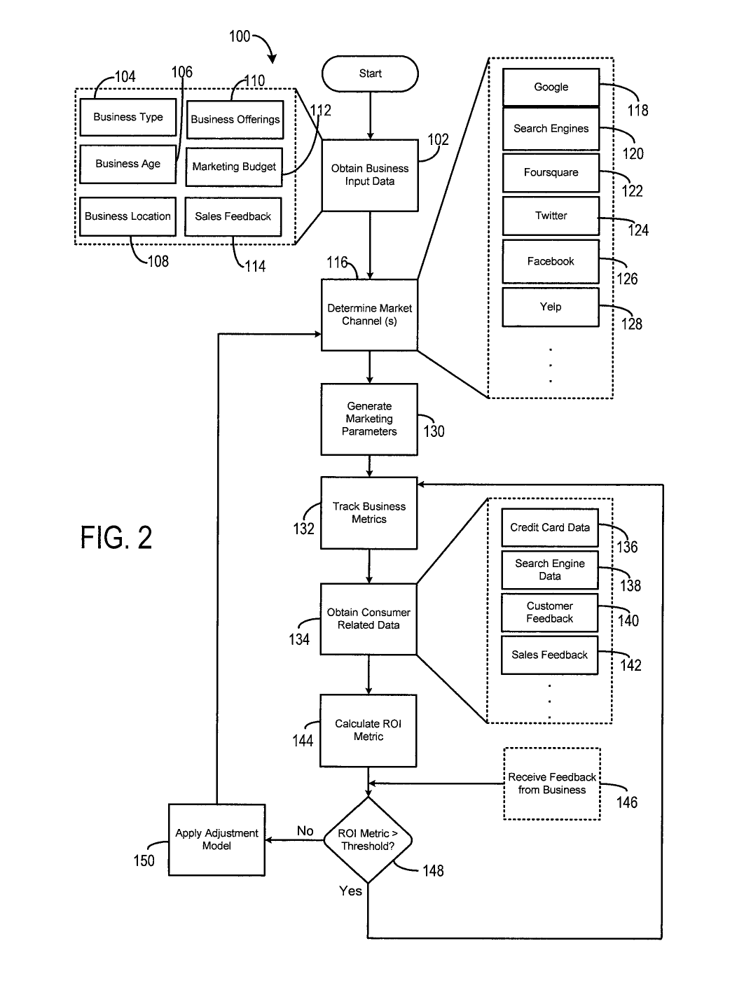

Referring now to FIG. 2, a flow chart setting forth exemplary steps 100 for automatically assigning marketing allocations for a business to one or more marketing channels is provided. To start the process, the business input data 12 of FIG. 1 is obtained at process block 102. The business input data may include any data related to the business, for example. As one non-limiting example, the business input data may be a business type, as shown at block 104, such as a restaurant, department store, salon, health club, supermarket, bank, movie theater, ticket agency, pharmacy, taxi service, and service providers, among other things. The business input data may also include an age of the business as shown at block 106, such as the number of years the company has been in business or the number of years the business has been in a particular region, state or city, for example.

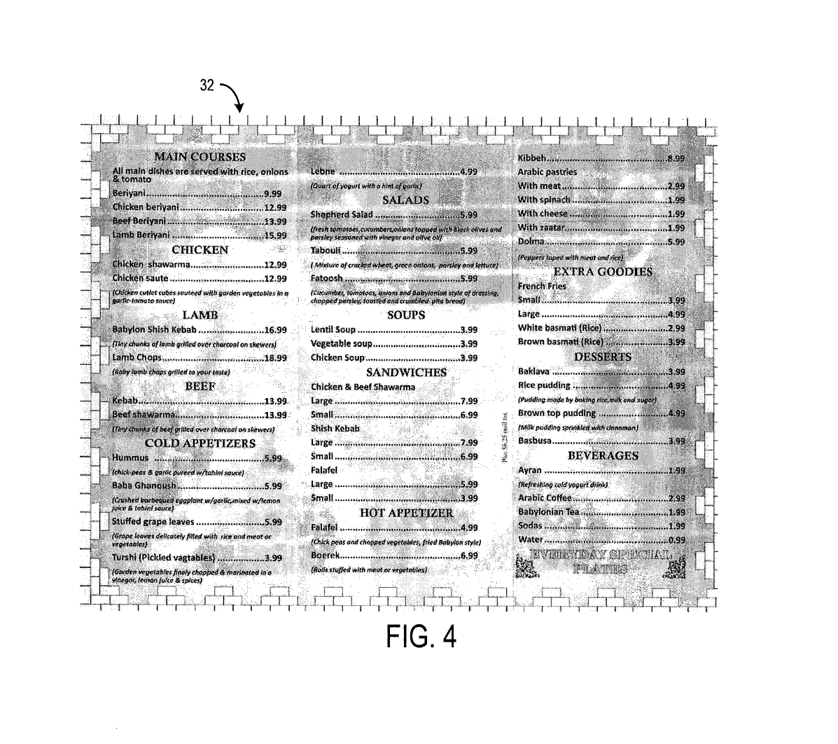

Other business input data may include a location of the business, as shown at block 108, for example. The business location 108 may include a business and/or home address, city, state, zip code and country, for example. In addition, business input data may include business offerings, as shown at block 110. If the business is a restaurant, for example, the business offerings 110 may include data obtained from a restaurant menu 32 as shown in FIG. 4, such as Menu Name, Section, Subsection, Section Text, Item Name, Item Description, Item Price, Item Options, and Notes. In the particular example of FIG. 4, Sections include “Main Courses”, “Chicken”, “Lamb”, “Beef”, “Cold Appetizers”, “Salads”, “Soups”, “Sandwiches”, “Hot Appetizer”, “Extra Goodies”, “Desserts”, and “Beverages”. Item Names include “Beriyani”, “Chichen Shawarma”, and “Lamb Chop”, for example. One Item Description is “Chicken cutlet cubes sautéed with garden vegetables in a garlic-tomato sauce”. Item Prices include, but are not limited to, “9.99”, “12.99”, and “13.99”. Item Options may include how well a meat dish is cooked (not shown in FIG. 4). Notes include “All main dishes are served with rice, onions & tomato”. As may be understood, the business input data related to the business offerings 110 are business-specific and may vary from one business to the next. Such data extraction and use is further detailed in U.S. Provisional Patent Application Ser. No. 61/818,713, filed May 2, 2013 and entitled “SYSTEMS AND METHODS FOR AUTOMATED DATA CLASSIFICATION, MANAGEMENT OF CROWD WORKER HIERARCHIES, AND OFFLINE CRAWLING,” and U.S. patent application Ser. No. 13/605,051, filed Sep. 6, 2012 and entitled “METHOD AND APPARATUS FOR FORMING A STRUCTURED DOCUMENT FROM UNSTRUCTURED INFORMATION.”

The business input data may further include a marketing budget, as shown at block 112, that is specified by the business. The marketing budget 112 may be a yearly, monthly, weekly, or daily budget, for example, that is specified by the business for different marketing allocations. Also, the budget 112 may be dynamically allocated, for example, such as tied to a point-of-sale or sale analysis system that provide real-time or updated sales information to facilitate dynamic or adjustable budgets. The marketing budget 112, along with the other business input data, is provided to the investment engine 20 of FIG. 1 to automatically assign the marketing budget to different marketing channels to optimize the business's profitability.

Additionally, business input data may be provided from data obtained from sales feedback, as shown at block 114. Sales feedback data 114 may include, but is not limited to, profits, losses, a quantity of product or services sold, a location where the product or services were sold, a past performance of the business's marketing allocations, performance of marketing allocations for similar businesses in the industry, the business's best practices, data related to consumers' receptiveness of a particular marketing allocation, or a time frame (e.g., a particular season, holiday, month, time of day, etc.) the product or services were sold in, for example. In one non-limiting example, if the business uses point-of-sale or online scheduling services or GoDaddy's Web Hosting or Online Bookkeeping services, the business input data may automatically be gathered through GoDaddy and provided to the investment engine. Furthermore, if using GoDaddy's online shopping cart services for their website, the quantity of product or services sold can be tracked and income and expense reports can be delivered automatically. Since such services allow the business to accept payments from their clients online, additional business data, such as client's name, billing address, and purchasing patterns may be obtained from the client's credit card information and provided to the investment engine. Additionally, or alternatively, any data related to the business type 104, business age 106, business location 108, business offerings 110 or marketing budget 112 may be obtained directly through such additional services or automatically extracted from databases. Thus, the business itself does not necessarily have to provide this information to the marketing platform.

The above-described business input data described with respect to blocks 104, 106, 108, 110, 112 and 114 is used by the investment engine 20 of FIG. 1 to determine which marketing channels 22 to utilize. For example, a small restaurant may not see a high rate of return if all of their marketing allocations are put on a social media network, such as Twitter. The small restaurant may see higher returns when the marketing allocations are put on Yelp, for example. However, using the small restaurant example, it may be difficult, especially for smaller businesses, to determine which marketing channel to assign marketing allocations to in order to receive the highest rate of return when choosing between similar marketing channels such as Google, Yahoo, or Bing, which are all search engines. Therefore, once the investment engine has received the business input data at process block 102, the marketing channels may automatically be determined at process block 116 to optimize the business's marketing resources. Additionally or alternatively, the investment engine may aggregate business input data for a large number of businesses across different verticals and geographies and use aggregated information. As noted above, by aggregating and selecting verticals and geographies and uses, the present disclosure can “predict” the best allocation for a given business in a given category and/or in a given geography.

Several marketing channels are available for the investment engine to choose from at process block 116. Some non-limiting examples are provided in FIG. 2. For example, Google's various products, as shown at block 118, may be an appropriate marketing channel to apply a business's marketing allocations to in the form of a search engine advertisement, for example. Specific search engines (which may include Google's search engine), as shown at block 120, may be other marketing channel options and may include other search engine websites such as Yahoo or Bing, for example. Other marketing channels may include Yelp and Foursquare, as shown at blocks 122 and 124, respectively, for locally marketing a business's offerings, for example. Alternatively, social media networks, such as Twitter and Facebook, as shown at blocks 126 and 128, respectively, may be assigned as marketing channels. For example, the investment engine may allocate resources to Tweet coupons, launch an advertisement on Facebook, or embed a widget on a social media network's website to help the business optimize profitability based on the previously gathered business input data at process block 102. Additionally, direct mail may be another marketing channel appropriate to apply a business's marketing allocations to.

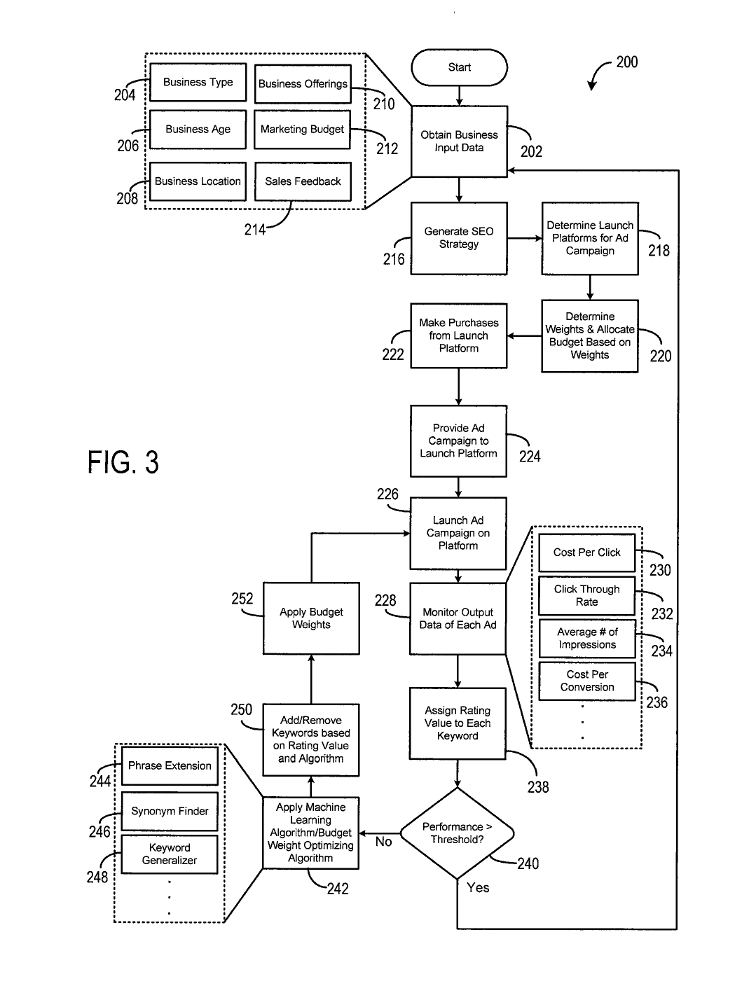

Once the marketing channel(s) has been determined at process block 116, the investment engine may generate marketing parameters at process block 130. Generating marketing parameters at process block 130 may include applying the marketing allocations, such as advertisements, coupons, or widgets, to the appropriate marketing channels. In one non-limiting example, the investment engine may automate search engine marketing for the business, which will be described later with reference to FIG. 3. As previously described, generating marketing parameters at process block 130 may also include launching advertisements or coupons related to the business on social media networks or search engines, for example, in order to generate consumer activity.

In another non-limiting example, the investment engine may generate non-discrete marketing parameters at process block 116, such as marketing campaigns that are launched on multiple marketing channels. Additionally, or alternatively, the marketing campaigns may be in the form of a drip campaign where the investment engine sends, or “drips,” a pre-written set of messages (e.g., email) to customers or prospects over a pre-determined time period, and the messages are automatically dripped in a series applicable to a specific behavior or status of the recipient. Despite the combination of marketing allocations that are applied to the marketing channels at process block 130, business metrics are tracked at process block 132 in response to the consumer activity generated.

Tracking business metrics at process block 132 may include, for example, recording the quantity of consumer purchases related to the different business offerings provided by the business and tracking revenues received from the consumer purchases. As a result of the consumer purchases, consumer related data may then be obtained at process block 134. The consumer related data obtained at process block 134 may include, but is not limited to, any output data related to the consumer activity. For example, as shown at block 136, credit card data related to the consumer may be obtained, as previously discussed. In addition, search engine data, as shown at block 138, such as keywords searched by consumers, may be consumer related data obtained at process block 134 and used by the DRAM to better optimize the business's profitability.

Customer feedback, as shown at block 140, may be another form of consumer related data that is obtained at process block 134. For example, if the business website provides a survey or area for comments/suggestions, for example, once a consumer has made a purchase, this data may also be used by the DRAM to adjust the marketing allocations to better optimize the business's profitability. Another example of consumer related data obtained at process block 134 may be sales feedback, as shown at block 142. Sales feedback data related to the consumer may include, for example, the consumer's previous purchases, frequency of purchases or the diversity of products or services purchased.

Once the consumer related data has been obtained at process block 134, the data may be stored in the remote content source 10 of FIG. 1 for retrieval by investment engine 20 at any time. Thus, the investment engine 20 may be continuously updating the marketing allocation strategy to optimize the business's profitability. Additionally, once the consumer related data has been obtained at process block 134, a return-on-investment (ROI) metric may be calculated at process block 144. The ROI metric 134 may be specific to a particular product or service provided by the business or to all products and services offered by the business. The ROI metric may be, for example, return on investment (ROI) of the marketing budget 112 calculated by gross sales changes. Other examples, of the ROI metric may include changes in profitability (net or gross) and the like. For example, if the ROI metric is a positive numeric value, this may indicate the marketing budget was allocated to the marketing allocations and marketing channels successfully. However, if the ROI metric is a negative numeric value, this indicates that the cost of the investment (i.e., the marketing budget) was greater than the gains (i.e., the revenues generated) received from the investment.

Once the ROI metric is calculated at process block 144, the business may optionally provide feedback, such as adjusting the marketing budget 112, at process block 146. The calculated ROI metric may then be compared to a predetermined threshold value to determine whether the marketing budget investment has achieved a desired performance at decision block 148. In some instances, the threshold may be an ROI predicted by aggregated business and consumer data. If the ROI metric is greater than the threshold at decision block 148, the investment engine may continue to allocate the business's marketing budget to the same marketing channels. However, if the ROI metric is not greater than the threshold at decision block 148, the investment engine may apply an adjustment model at process block 150 to help improve the ROI from the marketing budget.

Applying the adjustment model at process block 150 may include the investment engine adjusting the business input data (e.g., marketing budget, business offering prices, and the like), the marketing parameters 130 (i.e., the marketing allocations), and/or the marketing channels 116 in order to increase the ROI metric calculated at process block 144. The adjustment model 150 may also make adjustments to the above described data based on the consumer related data obtained at process block 134. Once the adjustment model 150 has been applied, the investment engine determines which marketing channels to allocate the marketing budge to at process block 116. The steps are then repeated. Notably, even when the ROI metric is greater than the threshold at decision block 148, the process may not be terminated. This is because marketing is a dynamic process that, to be most effective, should react and adjust to market and consumer changes. Thus, unlike the above-described traditional means of administering marketing budgets, the present systems and methods are designed to be iterative and adjustable to identify and react to changes in the market automatically.

As one non-limiting example, if the calculated ROI metric at process block 144 is below the predetermined threshold value, the investment engine may determine that a small number of consumers are clicking on or using the coupons launched on Twitter at process block 130 for a small, local restaurant. However, the business metrics tracked at process block 132, for example, indicate that the advertisements and coupons allocated to Yelp for the small, local restaurant are being used at a higher rate, as compared to the coupons on Twitter. As this is recognized by the system, the adjustment model can be used at process block 150 to automatically re-allocate more of the business's budget, for example, to marketing allocations on the Yelp marketing channel and decrease, or even eliminate, the portion of the marketing budget for the Twitter marketing channel. Thus, the business no longer needs to be concerned with how to best allocate marketing budgets to different marketing channels, even in a changing market. The investment engine can automatically allocate the marketing budget, make adjustments to marketing allocations and channels to improve the ROI metric, while incorporating consumer related data into an adjustment model.

Turning now to FIG. 3, a flow chart setting forth exemplary steps 200 for automating search engine marketing for a business is provided. Typically, search engine marketing involves the business creating advertising accounts on search engines (e.g., Adwords accounts on Google), determining what search keywords to target, monitoring success metrics and adjusting and redistributing the business's marketing budget to optimize profitability. Because of the complexity of this task, very few small businesses advertise using search engine marketing despite the tangible marketing benefits that can be achieved and, even when a small business does attempt to use these marketing resources, the results are often less than desired. Thus, the investment engine 20 of FIG. 1 may automatically determine what search keyword(s) should activate an advertisement campaign (i.e., marketing allocations) for a business when the keyword(s) are entered by consumers on a search engine interface, for example.

Returning to FIG. 3, to start the process, business input data 12 of FIG. 1 is obtained at process block 202. The business input data may include any data related to the business, for example. As one non-limiting example, the business input data may be a business type, as shown at block 204, such as a restaurant, department store, salon, health club, supermarket, bank, movie theater, ticket agency, pharmacy, taxi service, and service providers, among other things. The business input data may also include an age of the business as shown at block 206, such as the number of years the company has been in business or the number of years the business has been in a particular region, state or city, for example.

Other business input data may include a location of the business, as shown at block 208, for example. The business location 208 may include a business and/or home address, city, state, zip code and country, for example. In addition, business input data may include business offerings, as shown at block 210. If the business is a restaurant, for example, the business offerings 210 may include data obtained from a restaurant menu 32 as shown in FIG. 4, such as Menu Name, Section, Subsection, Section Text, Item Name, Item Description, Item Price, Item Options, and Notes. As may be understood, the business input data related to the business offerings 210 are business-specific and may vary from one business to the next.

The business input data may further include a marketing budget, as shown at block 212, that is specified by the business. The marketing budget 212 may be a yearly, monthly, or weekly budget, for example, that is specified by the business for an advertising campaign, for example, to be launched on a search engine. The marketing budget 212, along with the other business input data, is provided to the investment engine 20 of FIG. 1 to automatically generate search engine optimization (SEO) strategies and run search engine advertisement campaigns for a business.

Additionally, business input data may be provided to the investment engine from data obtained from sales feedback, as shown at block 214. Sales feedback data 214 may include, but is not limited to, profits, losses, a quantity of product or services sold, a location where the product or services were sold, a past performance of the business's marketing campaigns, performance of marketing campaigns for similar businesses in the industry, the business's best practices, data related to consumers' receptiveness of a particular marketing campaign, or a time frame (e.g., a particular season, holiday, month, time of day, etc.) the product or services were sold in, for example. In one non-limiting example, if the business uses GoDaddy's Web Hosting or Online Bookkeeping services, the business input data may automatically be gathered through GoDaddy and provided to the investment engine.

Once the business input data is obtained at process block 202, the investment engine generates a search engine optimization (SEO) strategy at process block 216. The SEO strategy 216 may include, for example, generating a list of business specific keywords based upon some, or all, of the business input data obtained at process block 202. For example, in the case where the business is a restaurant, the investment engine may determine that the menu items offered by the restaurant may be candidate keywords for the keyword list generated at process block 216 or for use in ads. With reference to the menu 32 in FIG. 4, for example, the investment engine may determine that menu items, such as “Chicken beriyani” and “Beef Beriyani” are adequate keywords to include in the SEO strategy at process block 216. These menu items may be good candidates for the keyword list because they can target consumers that are searching for the offering provided by the business. Additionally, or alternatively, the list of keywords generated at process block 216 can be based on the business type 204 or sub-type (e.g., cuisines), business name (e.g., Dim Sum, Restaurant), menu item prices, or any other business input data obtained at process block 202. As another example, in the case where the business is a service business, the investment engine may determine that the service items offered by the business may be candidate keywords for the keyword list generated at process block 216.

Once the SEO strategy is generated at process block 216, the launch platform(s) is determined for the advertisement campaign to be launched at process block 218. The launch platform may include, but is not limited to, search engines, social media networks, and direct mail as previously described. Weights are then assigned to each keyword in the list of search keywords and the marketing budget 212 is allocated to each keyword based on the weights at process block 220. For businesses using the investment engine for the first time, the marketing budget may be assigned evenly across each of the keywords, for example, at process block 220. Once the keyword weights and marketing budget are determined at process block 220, accounts are purchased from one or more launch platforms (e.g., search engines) at process block 222.

Thereafter, the advertisement campaign and the list of keywords to be advertised on are provided to the launch platform at process block 224. The marketing budget and information related to the budget allocation for the keywords, which is inline with what the business has requested through the investment engine, may also be provided to the launch platform at process block 224. The advertisement campaign may then be launched by the launch platform at process block 226. In one non-limiting example, the investment engine may request that the advertisement campaign should be activated only when target searches occur within a predefined distance (e.g., 10 miles of the latitude/longitude coordinates) from the business, for example, at process block 226.

While the advertisement campaign is running at process block 226, the investment engine can monitor output data associated with each advertisement at process block 228. The output data 228 may include for example cost per click (CPC) data, as shown at block 230. CPC data 230 may be used when the marketing budget has been predetermined, such that when the budget is hit, the advertisement is removed from the launch platform. For example, a website that has a CPC rate of $0.10 and provides 1,000 click-throughs would bill $100 ($0.10×1000) to the business. The amount that the business pays for a click may be set by a machine learning algorithm, as will be described in further detail below. Additionally, or alternatively, the output data obtained at process block 228 may include the click through rates (CTRs), as shown at block 232, and number of impressions, as shown at block 234. The CTR 232 may be a ratio specifying how often consumers who see one of the advertisements in the advertisement campaign end up clicking it. More specifically, the CTR 232 is the number of clicks that the advertisement receives divided by the number of impressions 234 (i.e., the number of times the advertisement is shown) on the launch platform. For example, if an advertisement receives five clicks and 1000 impressions, then the CTR 232 is 0.5%. Thus, a high CTR 232 can be a good indication that consumers find the advertisement helpful and relevant, for example.

Another example of output data that may be monitored at process block 228 for each advertisement in the advertisement campaign is the cost per conversion, as shown at block 236. The cost per conversion 236 may be the ratio of the number of advertisement views and the number of successful conversions (i.e., purchases, signups, participation or whatever the objective of the advertisement is) resulting from those advertisement views. For example, if the investment engine allocates $100 on advertising for 100 visitors, at $1 each, but only receives 2 sales, the resulting cost per conversion is $50 ($100/2).

Based on the above described output data to be monitored at process block 228, a rating value may be calculated and assigned to each keyword at process block 238. The rating value may be a numeric value, for example, indicative of the quality of the keyword(s) as related to the output data acquired at process block 228. For example, if the advertisement (e.g., for the restaurant associated with the restaurant menu 32 of FIG. 4) is launched at process block 226 as a result of consumers searching for keywords (e.g., “chicken beriyani”) generated at process block 216, and the launched advertisement results in a low cost per click 230 and a low cost per conversion 236 value, a higher rating value may be given to that keyword. Whereas, if the advertisement launched at process block 226 results in a high cost per click 230 and a high cost per conversion 236 value, a lower rating value may be given to that keyword at process block 238.

The rating value assigned at process block 238 may then be compared to a predetermined threshold value to determine whether the output data obtained at process block 228 is evaluated at decision block 240. The rating value may be calculated using an algorithm, for example, programmed in the processor 16 of FIG. 1. The algorithm may include all, or a portion of, the business input data and output data to determine whether the output data is achieving the desired results at decision block 240. If the output data is performing as desired at decision block 240, the investment engine may continue to allocate the business's marketing budget with the same weights to the same keywords as generated at process block 220. However, if the output data is not performing as desired at decision block 240, the investment engine applies a machine learning algorithm and budget weight optimization algorithm at process block 242 to help improve the output data and assign the appropriate budget weights to the list of keywords.

Applying the machine learning algorithm and budget weight optimization algorithm at process block 242 may include the investment engine adjusting the business input data (e.g., marketing budget, business offering prices, etc.), the marketing parameters 130 (i.e., the marketing allocations), and/or the list of keywords in order to increase the values of the output data calculated at process block 228. The machine learning algorithm applied at process block 242 may be an integer program, for example, that monitors the CPC 230, the CTR 232, and the average number of impressions 234 to determine the budget weights needed for each keyword to maximize the number of clicks at the requested marketing budget 212. In addition, the integer program may be constrained to provide some variance in the keywords being display on the search engine interface, for example, to ensure that each keyword is given a budget at least that of its CPC 230.

In one non-limiting example, the machine learning algorithm 242, which may be an evolutionary machine learning algorithm, may be configured to initiate the investment engine to search for and discover new keywords at process block 250 that may increase the number of clicks and/or conversions for the pre-specified marketing budget 212. The machine learning algorithm 242 may be based on genetic mutations, for example, that use a set of mutation functions, such as phrase splitting, word joining, word stemming, order changing, and so on, to construct new candidate keywords at process block 250 that the investment engine tests out, using a small budget, to see if the keywords generate output data with high rating vales at process block 238. If the keyword does well (i.e., is assigned a high rating value), the budget weight optimizing algorithm at process block 242 will promote it to have a higher weight at process block 252. Otherwise, the keyword(s) may be eliminated at process block 250 after a number of rounds of experimentation, along with other keywords that perform poorly.

Another example of the machine learning algorithm at process block 242 may be a phrase extension mutator, as shown at block 244. The phrase extension mutator 244 may be configured to combine keywords that were previously generated at process block 216 with each other. For example, with reference to the menu 32 of FIG. 4, if the keywords generated at process block 216 include “chicken,” “beef,” and “shawarma,” for example, the phrase extension mutator 244 may combine the keywords into the complete menu items “chicken shawarma” and “beef shawarma,” as shown on the menu 32. Additionally, or alternatively, the phrase extension mutator 244 may combine keywords that were generated at process block 216 with a set of handpicked verbs or phrases for the particular business category 204 that the business is defined by. For example, if the business's business type 204 is a restaurant, the set of handpicked verbs or phrases may include, “hungry, get,” “order,” “pickup,” “looking for,” or “eat,” since consumers may likely be searching for these specific actions related to food items. Because some keywords are based on menu item text while others are inferred for venue-level data, the investment engine may track the providence of each keyword and use it in the mutation functions to help guide the mutations to construct phrases that are likely grammatically correct.

Another example of the machine learning algorithm at process block 242 may be a synonym finder, as shown at block 246. The synonym finder 246 may be configured to randomly substitutes words in a given phrase for known synonyms or similar items and categories associated with the keyword. In so doing, the synonym finder 246 will likely generate a keyword string that has fewer parties bidding on it and thus, has a lower CPC 230. Additionally, or alternatively, the machine learning algorithm at process block 242 may be a keyword generalizer, as shown at block 248. The keyword generalizer 248 may be configured to generalize a keyword so that it appears in more searches and thus has more impressions 234 by randomly removing words that do not appear frequently in the target language. The keyword generalizer 248 may also be configured to remove pluralization or stop words, for example.

Once the machine learning algorithm and budget weight optimization algorithm have been applied at process block 242, the investment engine may be configured to add or remove keywords at process block 250 from the list of keywords generated at process block 216. The keywords may be added, removed, or remain in the list of key words at process block 250 based on both the rating value determined at process block 238 and algorithms applied at process block 242. After the keyword list is modified, the investment engine may re-apply budget weights to each keyword at process block 252 based on the business's marketing budget 212, and the advertisement campaign is re-launched at process block 226. The steps are then repeated until the rating values calculated at process block 238 are above the predetermined threshold value and the output data has achieved a desired performance at decision block 240.

In an alternative embodiment, the investment engine may be configured to periodically direct the advertisements to the Locu places page or other landing page and offer discount coupons to the consumer that can be redeemed by the local business. In this way, the process can be tied back to the Online Store and, when convergence statistics are not readily available from the business, they can be estimated by paying for advertisements in this way. In any case, by tracking which coupons are redeemed, an accurate cost per conversion metric may be calculated at process block 228, which may be used in place of the CPC 230 when optimizing budget weights at process block 252.

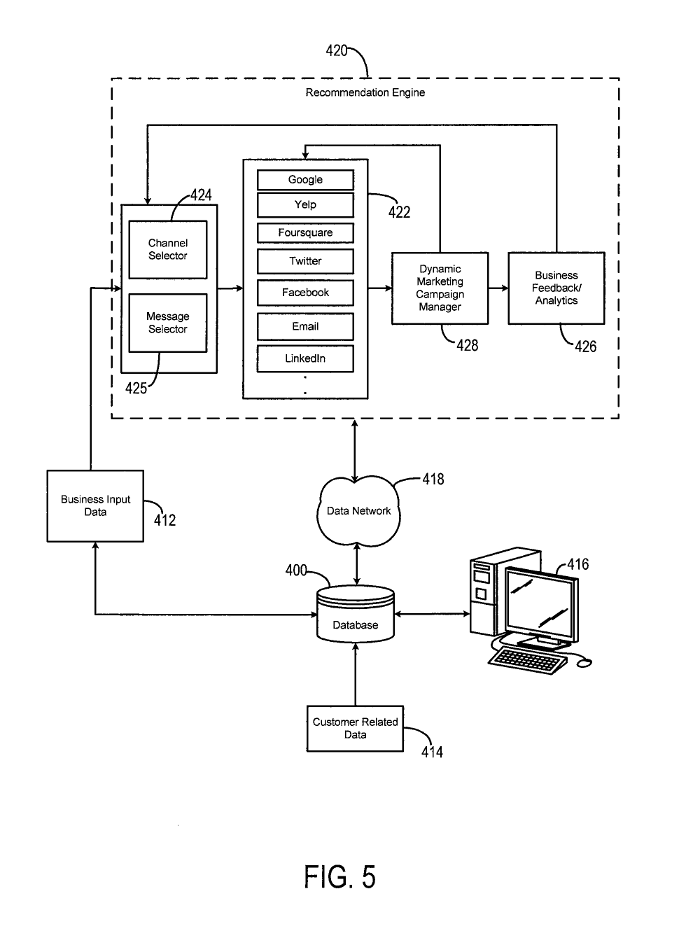

Referring now to FIG. 5, a schematic view of another environment in which the invention may operate is shown. The environment includes one or more remote content sources 400, such as a database or non-transitory, computer-readable storage medium on which business input data 412 and customer related data 414 corresponding to a business are stored. A processor 416 may be configured to access the remote content source 400 to store market data, for example, related to the business input data 412 and consumer related data 414. In one non-limiting example, the remote content source is a shared, central contacts database. The remote content source 400 is connected, via a data communication network 418 such as the Internet, to a recommendation engine 420 in accordance with an embodiment of the invention.

As described in more detail below, the recommendation engine 420 may be configured to receive the input data 412 and customer related data 414 to determine which marketing channels 422, such as email, social, and local networks, for example, the business should launch their marketing campaign on, as well as what content to include in the marketing campaign, in order to improve marketing. As will be further described, the business input data 412 may include, but is not limited to, the business type, business applications, related businesses, business location, business contacts, business offerings, business news, business branding, age of the business, a marketing budget, business's preferences, target demographic information, marketing feedback data, and the like. The customer related data 414 may include any output data received from the launch of the marketing campaign. The output data may include, but is not limited to, customer feedback and comments, customer preferences, customer purchases, coupon redemptions, marketing campaign sign-ups, customer campaign sharing, social network activity, and the like.

The recommendation engine 420 may include a channel selector 424 that chooses, based upon, but not limited to, the business input data 412, the customer related data 414, and feedback from the business 426, which marketing channels 422 to distribute the business's marketing allocations (i.e., advertisements, coupons, and the like) according to the business's marketing strategy. The recommendation engine 420 may further include a message selector 425 that chooses, based upon, but not limited to the business input data 412, the customer related data 414, and feedback from the business 426, what content (i.e., graphics, formats, styles, logos, text, coupon amount, offer timeframe, and the like) to include in the business's marketing allocations. A dynamic marketing campaign manager 428 may be configured to receive customer related data 414 that corresponds to the consumer activity generated on the targeted marketing channels 422 and generate a report. Based on the report, the recommendation engine 420 may recommend to the business which marketing allocations, marketing contents, and/or marketing channels 422 to launch the recommend marketing campaign on to improve the business's marketing performance.

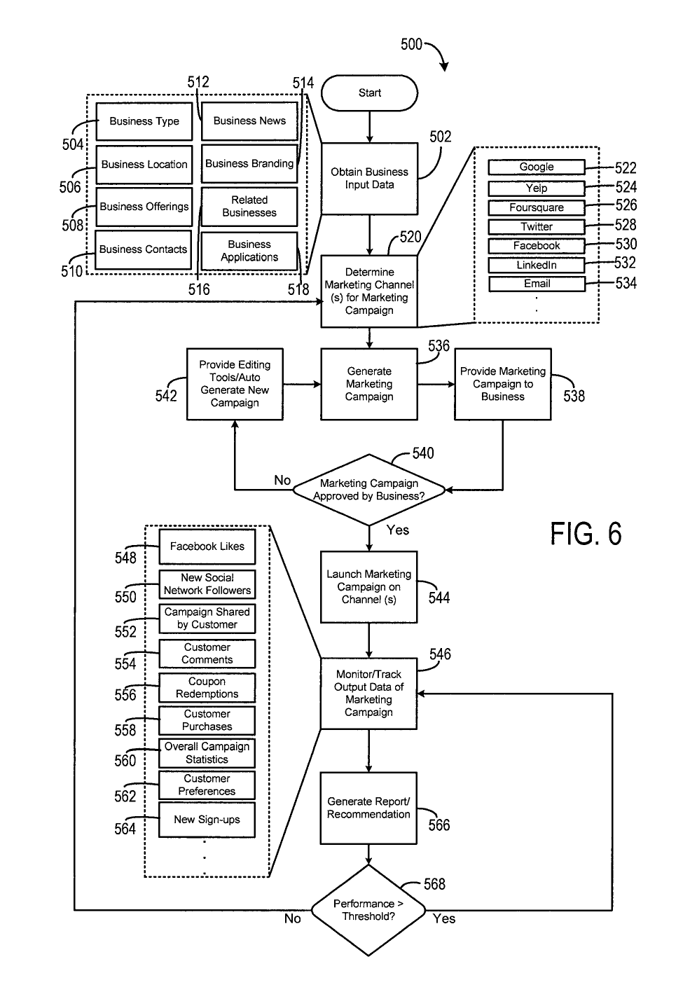

Referring now to FIG. 6, a flow chart setting forth exemplary steps 500 for analyzing current marketing practices and generating customized marketing recommendations for a business is provided. To start the process, the business input data 412 of FIG. 5 is obtained at process block 502. The business input data may include any data related to the business, for example. As one non-limiting example, the business input data may be a business type, as shown at block 504, such as a restaurant, department store, salon, health club, supermarket, bank, movie theater, ticket agency, pharmacy, taxi service, and service providers, among other things. As will be described in further detail below, the business type identified at block 504 may help the recommendation engine apply vertical specific marketing tactics that help determine what marketing channels to launch a business's marketing campaign on. For example, the recommendation engine may decide that a real estate agent may have a more successful marketing campaign launched on LinkedIn than on Facebook.

The business input data obtained at process block 502 may also include an age of the business, such as the number of years the company has been in business or the number of years the business has been in a particular region, state or city, for example. Other business input data may include a location of the business, as shown at block 506, for example. The business location 506 may include a business and/or home address, city, state, zip code and country, for example.

In addition, business input data may include business offerings, as shown at block 508. If the business is a restaurant, for example, the business offerings 508 may include data obtained from the restaurant menu 32 as shown in FIG. 4, such as Menu Name, Section, Subsection, Section Text, Item Name, Item Description, Item Price, Item Options, and Notes. In the particular example of FIG. 4, Sections include “Main Courses”, “Chicken”, “Lamb”, “Beef”, “Cold Appetizers”, “Salads”, “Soups”, “Sandwiches”, “Hot Appetizer”, “Extra Goodies”, “Desserts”, and “Beverages”. Item Names include “Beriyani”, “Chichen Shawarma”, and “Lamb Chop”, for example. One Item Description is “Chicken cutlet cubes sautéed with garden vegetables in a garlic-tomato sauce”. Item Prices include, but are not limited to, “9.99”, “12.99”, and “13.99”. Item Options may include how well a meat dish is cooked (not shown in FIG. 4). Notes include “All main dishes are served with rice, onions & tomato”. As may be understood, the business input data related to the business offerings 508 are business-specific and may vary from one business to the next.

The business input data may further include the business contacts, as shown at block 510 in FIG. 6. The business contacts (i.e., customer information) may be stored in the central contacts database 400 of FIG. 4 and may be shared across some or all business applications, as shown at block 518, and as will be discussed in further detail below. For example, when a business user signs up for any business application 518 (e.g., GoDaddy's Website Builder, Quick Shopping Cart, Spark, GetFound, etc.), all information about the user is sent to the centralized, shared contact database. The central contact database may keep business users from having to manage contacts in each separate business application 518 using its own contact database. The central contact database may store other business users' input data and is accessible to other business applications that users sign up for. Thus, when business users sign up for any service or business application 518, provided by GoDaddy for example, the business contacts 510 are available from all other business applications 518 and services. For example, if GoDaddy's Online Bookkeeping system shares the central contacts database, the recommendation engine knows about the business' purchase history and any business input data obtained at process block 502, for example. The business contacts 510 may also include, but is not limited to, social network profiles (e.g., Facebook, Twitter, and Yelp profiles) or demographic data related to the business. Therefore, the central contacts database provides a comprehensive view of the business users and their customers.

Still referring to FIG. 6, business news, as shown at block 512, may be another form of business input data obtained at process block 502. Business news 512 may include previous newsletters, for example, used by the business or current events related to the business. Input data obtained from business news 512 can help the recommendation engine with timing strategies for releasing the business's marketing campaign. As a non-limiting example, the recommendation engine may be able to determine when to release the marketing campaign so that the campaign is viewed by the maximum number of people.

Business branding, as shown at block 514, may be yet another form of business input data obtained at process block 502. Data obtained from business branding 514 may include any data related to the business's branding strategy, product and service expectations, a past performance of the business's marketing campaigns, the business's best practices, data related to consumers' receptiveness of a particular marketing campaign, and the business logo, for example. Thus, any data that helps the business differentiate from competitors may be identified as data obtained from business branding 514 and may be provided to the recommendation engine to help launch a marketing campaign.

The business input data may also include related business data, as shown at block 516. Related business data 516 may include, but is not limited to, any general marketing best practices data, such as data related to similar businesses' marketing campaigns or data related to the performance of marketing campaigns for similar businesses in the industry. For example, if the current business is a restaurant, the related business data 516 may include current coupon discounts being offered by other restaurants with similar business offerings 508. This related business data 516 may then used by the recommendation engine to generate a marketing campaign strategy that offers a more appealing discount, for example, or a better timing strategy for releasing the marketing campaign for the current restaurant. Additionally, or alternatively, the recommendation engine may recommend that the current restaurant launch the marketing campaign on a different marketing channel than the related business if the marketing campaign of the similar business was unsuccessful.

The business input data may further include data obtained from the business's applications 518. As previously described, business applications 518 may include any applications used by the business, such as web site building applications, sales and marketing applications, financial and accounting applications, online bookkeeping applications, and the like. In one non-limiting example, if the business uses GoDaddy's Web Hosting, Online Bookkeeping, or Shopping Cart services, the business input data may automatically be gathered through GoDaddy and provided to the recommendation engine. Furthermore, if using GoDaddy's web hosting or website building services for their website, the look and feel of the website can be analyzed by the message selector of the recommendation engine to generate corresponding marketing parameters (i.e., coupons, advertisements, etc.). Additionally, or alternatively, any data related to the business type 504, business location 506, business offerings 508, business contacts 510, business news 512, business branding 514 or related businesses 516 may be obtained directly through such additional services or automatically extracted from databases. Thus, the business itself does not necessarily have to provide this information to the marketing platform.

The above-described business input data described with respect to blocks 504, 506, 508, 510, 512, 514, 516 and 518 is used by the recommendation engine 420 of FIG. 5 to determine which marketing channels 422 and marketing allocations to utilize. For example, a small restaurant may not see a successful marketing campaign if all of the marketing allocations are put on a social media network, such as Twitter. The small restaurant may see a more successful marketing campaign when the marketing allocations are put on Yelp, for example. However, using the small restaurant example, it may be difficult, especially for smaller businesses, to determine which marketing channel to launch marketing campaigns on, or when to launch marketing campaigns, in order to generate new or continued business from customers, especially when choosing between similar marketing channels such as Facebook, LinkedIn, and Twitter, which are all social media networks. Therefore, once the recommendation engine has received the business input data at process block 502, the launch platform(s) for the marketing campaign may automatically be determined at process block 520 to help adjust or optimize the business's marketing strategy.

Several marketing channels are available for the recommendation engine to choose from at process block 520. Some non-limiting examples are provided in FIG. 6. For example, Google, as shown at block 522, may be an appropriate marketing channel to apply a business's marketing allocations to in the form of a search engine advertisement, for example. Specific search engines (which may include Google's search engine), may be other marketing channel options and may include other search engine websites such as Yahoo or Bing, for example. Other marketing channels may include Yelp and Foursquare, as shown at blocks 524 and 526, respectively, for locally marketing a business's offerings, for example. Alternatively, social media networks, such as Twitter, Facebook, and LinkedIn, as shown at blocks 528, 530, and 532, respectively, may be assigned as additional or alternative marketing channels. For example, the recommendation engine may recommend that the business Tweet coupons, launch an advertisement on Facebook, or embed a widget on a social media network's website to help the business optimize the marketing campaign based on the previously gathered business input data at process block 502. Additionally, or alternatively, the recommendation engine may choose to recommend that the business simply use email, as shown at block 534, as a marketing channel, such that the email 534 contains the marketing allocations (i.e., advertisements, coupons, newsletters, promotions, etc.). Additionally, direct mail may be another marketing channel appropriate to assign the marketing campaign to.

In the case where the business does not have an account on one or all of the marketing channels just described, the recommendation engine may automatically generate or recommend that the business create an account. For example, if the business does not have a Facebook 530 account, the recommendation engine may automatically generate an account using the previously acquired business input data 502 stored in the central database.

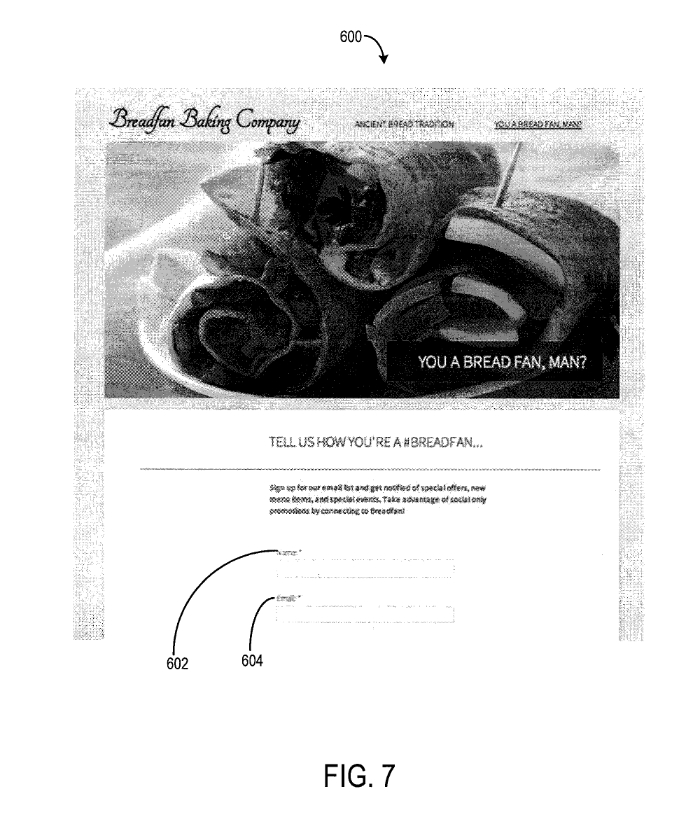

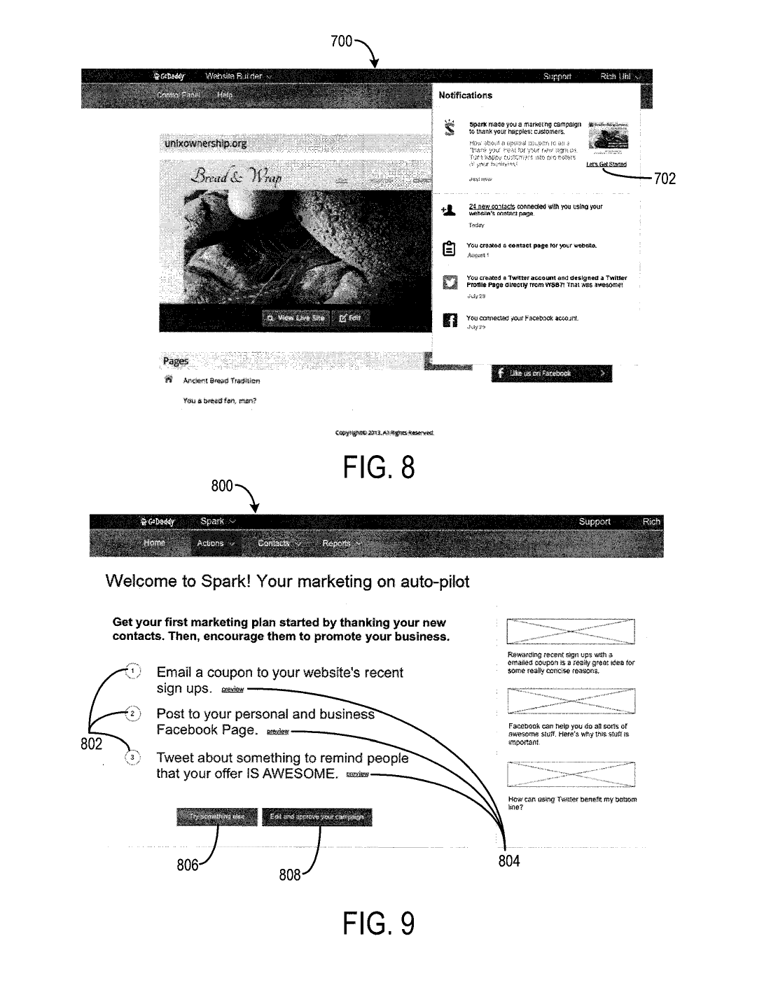

In addition to generating corresponding accounts for the business, the recommendation engine may be configured to automatically generate a contact page 600, as shown in FIG. 7, on the business's website for customers to receive marketing allocations from the business. The customer can simply enter a name 602 and an email address 604 on the contact page 600 and submit the request. The recommendation engine then stores the new sign-ups into the central contacts database 400, shown in FIG. 5, so that the marketing campaign can be sent to both new and existing customers of the business. Additionally, the recommendation engine may recommend that the business send a marketing allocation, such as a coupon, to new customers that may have recently signed up on the business's contact page 600 of FIG. 7. In one non-limiting example, the recommendation to send new customer sign-ups a coupon may appear on a user interface 700, as shown in FIG. 8. The recommendation may be provided in the form of a hyperlink 702, for example, that the business user may click on from the user interface 700 to send new customers a marketing allocation.

Returning to FIG. 6, once the marketing channel(s) has been determined at process block 520, the recommendation engine may generate a marketing campaign at process block 536. Generating the marketing campaign at process block 536 may include recommending marketing allocations, such as advertisements, coupons, or widgets, to be launched on the appropriate marketing channels. As previously described, generating the marketing campaign at process block 536 may also include recommending that the business launch advertisements or coupons related to the business on social media networks or search engines, for example, in order to generate consumer activity. In another non-limiting example, the recommendation engine may generate non-discrete marketing campaign at process block 520, such as marketing campaigns that are launched on multiple marketing channels. Additionally, or alternatively, the marketing campaigns may be in the form of a drip campaign where the investment engine sends, or “drips,” a pre-written set of messages (e.g., email) to customers or prospects over a pre-determined time period, and the messages are automatically dripped in a series applicable to a specific behavior or status of the recipient.

At process block 538, the recommendation engine may provide the marketing campaign to the business. More than one marketing campaign, however, may be generated and recommended to the business at process block 538. As shown on an exemplary user interface 800 in FIG. 9, the recommendation engine may provide the business with three separate marketing campaigns 802, for example. The first marketing campaign 802 may be to email a coupon to the business's website's recent sign-ups, for example. A second marketing campaign 802 may be to encourage the business to post a status to a personal or business Facebook page, for example. Additionally, or alternatively, the third marketing campaign 802 may be to Tweet about something (e.g., an upcoming sale) to remind customers of an upcoming event, for example. Thus, rather than the business having to determine details related to the marketing campaign, the recommendation engine provides marketing campaign options to the business, as shown in FIG. 9.

Returning to FIG. 6, once the marketing campaign is provided to the business at process block 538, the recommendation engine provides the business the option to approve or disapprove the marketing campaign at decision block 540. If the marketing campaign is approved by the business at decision block 540, the approved marketing campaign chosen by the business may be launched at process block 544 on the previously determined marketing channels. However, if the marketing campaign is not approved by the business at decision block 540, the recommendation engine may provide the business with editing tools to modify the current marketing campaign or generate a new marketing campaign at process block 542. Whether the current marketing campaign is modified by the business or a new marketing campaign is requested at process block 542, a marketing campaign is generated again at process block 536 and provided to the business at process block 538. This cycle repeats until the marketing campaign is approved by the business at decision block 540.

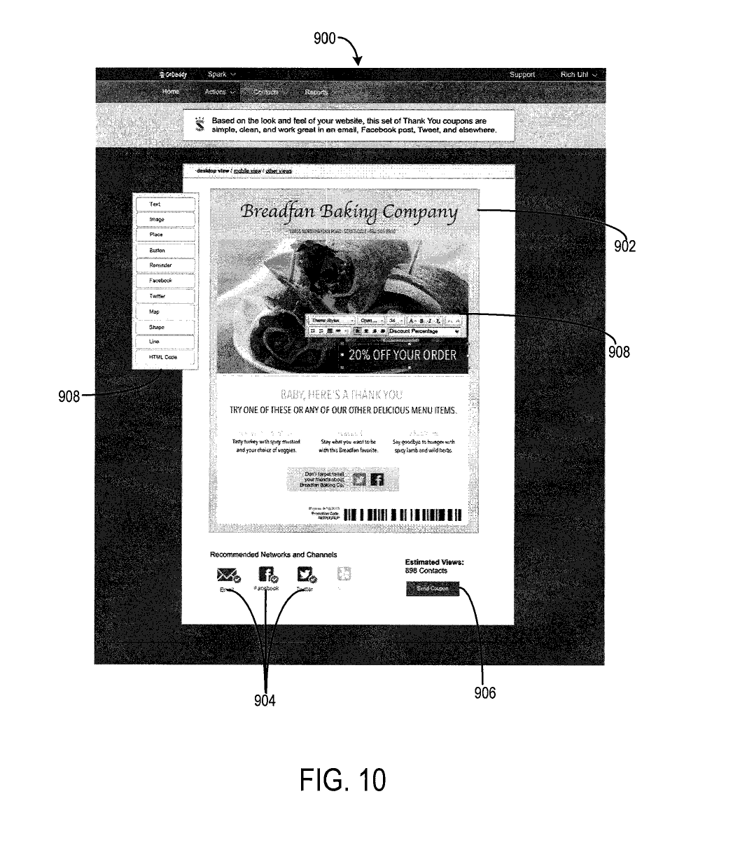

The above described processes for approving the marketing campaign can also be described with reference to FIGS. 9 and 10. As a non-limiting example, as shown in FIG. 9, the marketing campaign is provided to the business in the form of marketing campaign options 802 displayed on the user interface 800. The business user may preview each of the marketing campaign options 802 by selecting a preview link 804, for example. If the preview link 804 is selected, a marketing allocation 902 (e.g., a promotional coupon) may be displayed on a user interface 900, as shown in FIG. 10, for approval by the business. Returning to FIG. 9, if the business does not approve of the marketing campaign options 802 provided by the recommendation engine, a first button 806 may be provided on the user interface 800 that, when selected, generates new marketing campaign options 802. Alternatively, a second button 808 may be provided on the user interface 800 that, when selected, allows the business user to edit and/or approve the marketing campaign options 802.

Once the second button 808 is selected by the business user, one or more of the marketing campaign options 802 may be provided in the form of the marketing allocation 902, as shown in FIG. 10, such as a promotional coupon. The marketing allocation 902 may automatically be generated by the recommendation engine using templates and content obtained from business applications (e.g., GoDaddy's Website Builder or web hosting, Quick Shopping Cart, Spark, etc.) utilized by the business, for example. Thus, the appearance of the business's website (e.g., fonts, colors, images, business logo, headlines, taglines, headings, themes, cascading style sheets (CSS), etc.) may be applied to the marketing allocation 902.

The marketing allocation 902 may be displayed on the user interface 900 which may serve as a control panel, for example, for the business user. In some embodiments, the control panel may be accessed by administrative users to view and/or edit the marketing allocation 902. To edit the marketing allocation 902, one or more tool bars 908 may be provided. The tool bars 908 may also have a similar appearance to the tool bars provided by the business's website managing application (e.g., GoDaddy's Website Builder) such that the marketing allocation 902 is easy to modify for the business user. In one non-limiting example, the tool bars 908 may include options to change the text, font, style, spacing, theme style, image, and discount percentage of the marketing allocation 902. Additionally, or alternatively, the tool bars 908 may include options to modify the place or location where the marketing allocation 902 is valid, the amount of time the marketing allocation 902 is valid (i.e., an expiration date), the business offerings provided on the marketing allocation 902, or links to the business's social networks.

Once the business user is satisfied with the appearance and content of the marketing allocation 902, marketing channel recommendations 904 may be provided on the user interface 900 for the user to select. For example, the marketing channel recommendations 904 may be one or more of the marketing channels described with respect to FIG. 6 (e.g., Google, Yelp, Foursquare, Twitter, Facebook, LinkedIn, Email, etc.) that the marketing allocation 902 may be launched on. After the user selects one or more the marketing channel recommendations 904, a launch button 906 is provided for the user to click to launch the marketing allocation on the selected marketing channels. In addition, other marketing data, such as an estimated number of views the marketing allocation 902 will receive, maybe displayed on the user interface 900. Thus, the business is aware of an estimated number of business contacts that will receive the marketing allocation 902. Further, one or more marketing allocations may be sent to one or more marketing channels by the business to launch the marketing campaign.

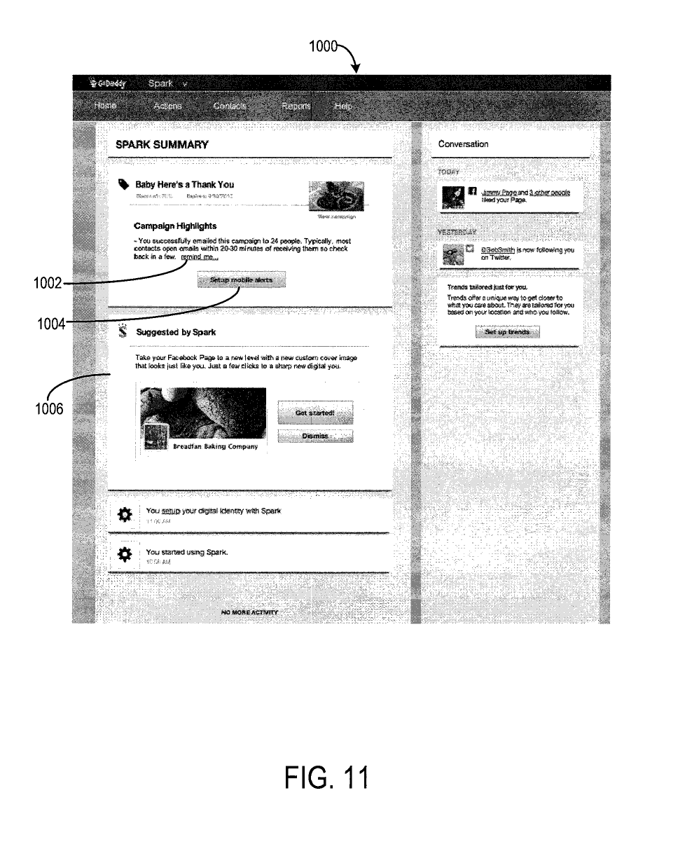

Referring now to FIG. 11, once the marketing campaign is launched, the recommendation engine may provide a summary of the newly launched marketing campaign on a user interface 1000. The summary may be provided in the form of a newsfeed, for example, and provide updates such as, “You successfully emailed this campaign to 24 people. Typically, most contacts open emails within 20-30 minutes of receiving them so check back in a few.” A reminder option 1002, in the form of a hyperlink for example, may also be provided so that the user can check on the status (i.e., the number of business contacts that viewed the campaign) of the marketing campaign. Additionally, an alert button 1004 may be provided on the user interface 1000 that is capable of configuring mobile alerts to be received by the user related to the marketing campaign status. In some embodiments, other suggestions 1006 may be provided on the newsfeed, such as suggestions on how the business may update social media networks, for example.

Returning again to FIG. 6, once the marketing campaign is launched at process block 544 on one or more of the marketing channels, the recommendation engine begins to monitor and track output data related to the marketing campaign at process block 546. The output data may be stored in the shared database 400 of FIG. 5, for example, and be used by the dynamic marketing campaign manager 428 to better optimize the recommended marketing campaigns. The output data may include, but is not limited to, customer related data, for example, as previously described with respect to FIG. 5. The output data may further include, but is not limited to, a quantity of Facebook likes 548, quantity of new social network followers 550, quantity of customers that shared the marketing campaign on social networks 552, quantity and content of customer comments 554, coupon redemptions 556, customer purchases 558, overall campaign statistics 560, customer preferences 562, and new sign-ups 564, as shown in FIG. 6.

More specifically, the quantity of Facebook likes 548 may be a numeric quantity of the customers and non-customers of the business who liked the marketing campaign, launched at process block 544, on Facebook. Similarly, the quantity of new social network followers 550 may be a numeric quantity of customers and non-customers of the business who started following the business as a result of the marketing campaign, for example. The quantity of new social network followers 550 may include, but is not limited to, new followers on Facebook, Twitter, Yelp, and the like. The quantity of customers that shared the marketing campaign on social networks 552 may include, but is not limited to, the quantity of customers that tweeted and/or re-tweeted the marketing campaign on Twitter, the quantity of customers that shared the marketing campaign on Facebook, Yelp, or Foursquare, for example, or posted the marketing campaign on Facebook. Thus, once the quantity of customers that shared the marketing campaign on social networks 552 is tracked and stored in the shared database, the recommendation engine can generate additional output data, such as a quantity of non-customers that received the marketing campaign due to existing customers sharing the campaign on social networks.

The quantity and content of customer comments 554 may also be output data that is monitored and tracked at process block 546. The quantity of customer comments 554 may be a numeric quantity of the customers and non-customers of the business who commented on one or more of the social networks that the marketing campaign was launched on. In addition, the content provided in the customer comments 554 may be monitored, thereby allowing the business to adjust the marketing campaign, for example, in response to the customer comments 554. As a non-limiting example, if the customer comments 554 are generally negative regarding the marketing campaign, the business may simply remove the marketing campaign from the social network or modify the marketing campaign to be more enticing for the customers.

Further, the quantity of coupon redemptions 556 may be monitored and tracked at process block 546. Of the quantity of coupon redemptions 556 tracked, the quantity of additional customer purchases 558 as a result of the launch of the marketing campaign, for example, may also be generated. Customer purchases 558 may include data related to the consumer's previous purchases, frequency of purchases or the diversity of products or services purchased. In addition, overall campaign statistics 560 may be tracked and may include, but are not limited to, the quantity of marketing allocations in the campaign sent, the date and time the marketing allocations were sent, the date and time the marketing allocations were viewed by customers, the quantity and/or percentage of marketing allocations opened via email, and the like.

Customer preferences 562 may be another form of output data that is obtained at process block 546. For example, if the business website provides a survey or area for comments/suggestions, for example, this data may be used by the dynamic marketing campaign manager to adjust the marketing campaign recommendations to better optimize the business's marketing strategy. Alternatively, the customer preferences 562 may include data related to the customers' preferred frequency of receiving newsletters, for example, provided by the business. Another example of output data obtained at process block 546 may be the quantity of new sign-ups 564 by non-customers, for example, who wish to receive the business's marketing campaign.

Once the output data has been obtained at process block 546, the data may be stored in the database 400 of FIG. 5 for retrieval by the recommendation engine 420 at any time. Thus, the recommendation engine 420 may be continuously updating the marketing campaign recommendations to optimize the business's marketing campaign strategy. Additionally, once output data has been obtained at process block 546, a report is generated at process block 566.

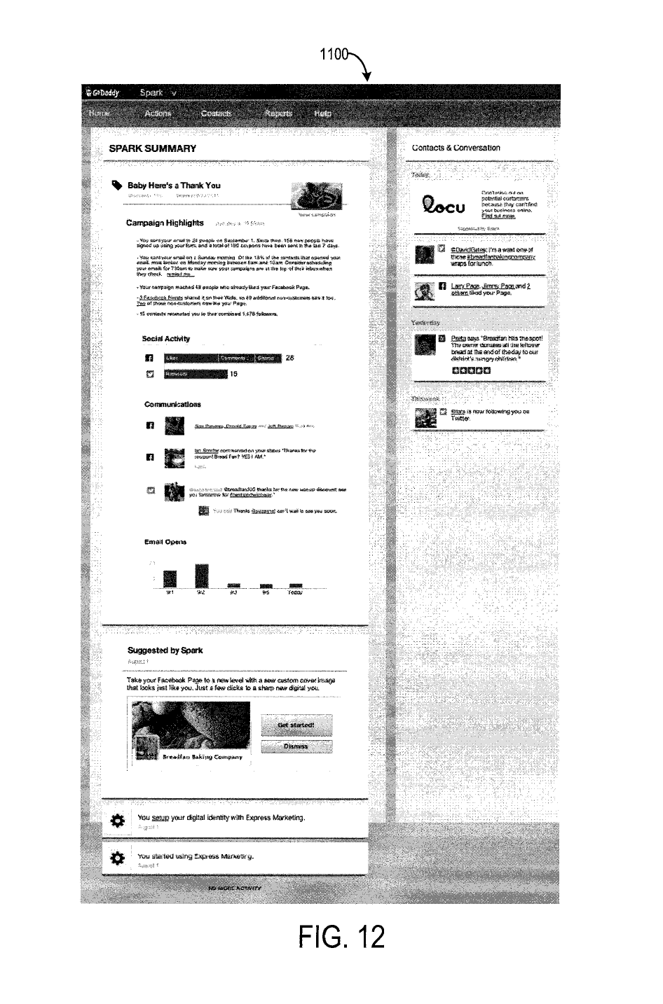

The report generated at process block 566 may include some or all of the output data as just described. Based on the acquired output data, recommendations related to the business's marketing campaign may be generated and displayed on the report at process block 566. An example report 1100 is shown in FIG. 12. The report 1100 may be displayed in a timeline format, for example, having a section that displays data related to the past, present, and future of the marketing campaign. The recommendations displayed on the report 1100 may be based on results of previous campaigns. For example, if the business uses a coupon with no redemptions, the recommendation engine learns that coupons are not recommended for that business. Similarly, the recommendation engine may recommend marketing channels that focus on the most receptive and/or most successful campaign channels and provide less emphasis on less effective marketing channels.

Further, based upon the output data, the recommendation engine may recommend that the business send an email at certain time of day. For example, if the overall campaign statistics indicate that of the 18% of the customers that opened the marketing campaign email, most looked at the email on a Monday morning between 8 am and 10 am, the recommendation engine may suggest on the report 1100 that the marketing campaign be emailed at 7:30 am to ensure the email is at the top of customers' email inboxes. As another non-limiting example, if the recommendation engine obtains coupon redemption and customer purchase data that indicates a significant number of customers redeemed a coupon and/or purchased additional goods from the business as a result of the marketing campaign, a recommendation may be provided on the report 1100 that suggests sending a thank you to the specific customers.

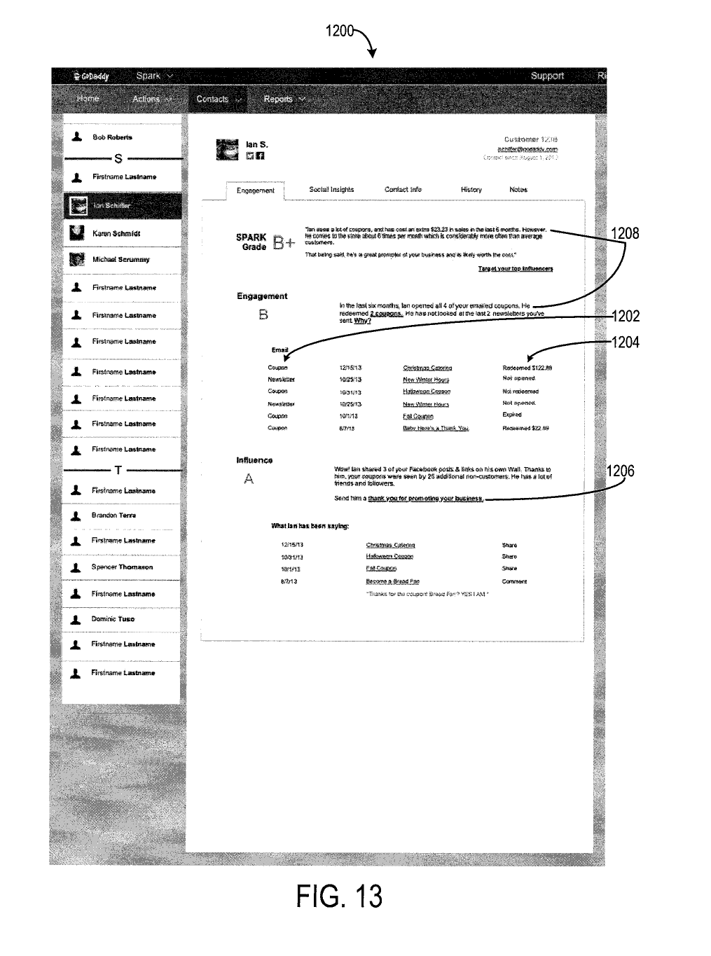

Referring now to FIG. 13, in some embodiments, an individual customer report 1200 may be generated by the recommendation engine for a customer that is stored in the central contacts database. The individual customer report 1200 may be for, but is not limited to, frequent customers of the business or customers that the business highly values. The individual customer report 1200 may be generated in a similar manner to the report 1100 of FIG. 12. However, the individual customer report 1200 may include output data and recommendations specific to that customer. For example, the report 1200 may display a history 1202 of the different marketing campaigns sent to the particular customer and a status 1204 of the customer's response to the different marketing campaigns. Based on the customer's history 1202 and status 1204 of the various marketing campaigns, the recommendation engine may provide one or more recommendations 1206 for the customer. For example, if the customer shared three of the business' marketing campaigns on a social network account that resulted in the marketing campaign being seen by twenty-five additional non-customers, the recommendation 1206 may suggest that the business send the customer a thank you for promoting the business.

In addition, the individual customer report 1200 may include marketing campaign statistics 1208 specific to the individual customer. For example, the campaign statistics 1208 may indicate that the customer has, in the last six months, opened all four of the emailed coupons and has redeemed two of the coupons which has led to an additional $23.23 in sales for the business. Therefore, the recommendation engine might suggest that the customer is a promoter of the business and likely worth the cost. Other campaign statistics 1208 may indicate, for example, that the customer has not looked at the last two newsletters sent. Thus, the recommendation engine may suggest possible reasons why the newsletters have not been opened, and might suggest sending the customer a coupon through a different marketing channel other than the customer's email, for example.

Returning again to FIG. 6, once the report and recommendations are generated at process block 566, the recommendation engine determines whether the performance of the marketing campaign has reached a predetermined threshold at decision block 568. The performance of the marketing campaign may be determined, at least in part, by the business' feedback and analysis 426 as described with respect to FIG. 5. The business feedback and analysis 426 may include sales feedback, for example, that may determine whether the marketing campaign has reached the predetermined threshold at decision block 568. Additionally or alternative, the performance of the marketing campaign may be determined, at least in part, by an increase in the quantity of output data obtained at process block 546. For example, if the quantity of Facebook likes 548, new social network followers 550, customers that shared the marketing campaign on social networks 552, customer comments 554, coupon redemptions 556, customer purchases 558, and new sign-ups 564, all increase by a predetermined value, the performance of the marketing campaign may have reached the predetermined threshold at decision block 568.

Regardless of the metric used to determine the performance of the marketing campaign at decision block 568, if the performance of the marketing campaign is above the predetermined threshold, the recommendation engine may continue to monitor and track the output data of the marketing campaign at process block 546. However, if the performance of the marketing campaign is below the predetermined threshold at decision block 568, the recommendation engine returns to process block 520 to determine different marketing channels for the marketing campaign. Thus, the previously described steps may be repeated until the performance of marketing campaign is above the predetermined threshold at decision block 568.

The present invention has been described in terms of one or more preferred embodiments, and it should be appreciated that many equivalents, alternatives, variations, and modifications, aside from those expressly stated, are possible and within the scope of the invention.

1. A system for automatically analyzing current marketing practices and generating marketing campaign recommendations for a business, the system comprising:
a non-transitory, computer-readable storage medium having stored there on input data configured to be analyzed by a recommendation engine;
a processor configured to receive the input data and access the non-transitory, computer-readable storage medium to execute the recommendation engine to carry out the steps of:
i) assigning the marketing campaign recommendations to at least one marketing channel based on the input data;
ii) launching at least one of the marketing campaign recommendations on the at least one marketing channel;
iii) receiving output data related to the at least one marketing campaign recommendations as consumers are exposed to the at least one marketing campaign recommendations;
iv) calculating a performance metric for the business related to the at least one marketing campaign recommendations;
v) comparing the performance metric to a predetermined threshold value;
vi) adjusting at least one of the input data, marketing campaign recommendations, and the at least one marketing channel to raise the performance metric toward the predetermined threshold value; and
vii) repeating steps i) through vi) until the performance metric is above the predetermined threshold value.

2. The system as recited in claim 1, wherein the processor is further configured to generate a user interface displaying the marketing campaign recommendations and configured to receive feedback to at least one of modify the marketing campaign recommendations and generate a new set of marketing campaign recommendations.

3. The system as recited in claim 2, wherein the user interface includes at least one tool bar for the business to utilize to modify the marketing campaign recommendations.

4. The system as recited in claim 1, wherein the processor is further configured to receive at least one of an approval and a disapproval of the marketing campaign recommendations from the business.

5. The system as recited in claim 1, wherein the input data includes at least one of a business type, a business age, a business location, a plurality of business offerings, business preferences, feedback data, business contacts, business news, business branding, related businesses, and business applications.

6. The system as recited in claim 1, wherein the marketing campaign recommendations include marketing allocations for the business, the marketing allocations including at least one of advertisements and coupons that are assigned to the at least one marketing channel.

7. The system as recited in claim 1, wherein the marketing channel includes at least one of a search engine, a social network, and email.

8. The system as recited in claim 1, wherein the output data related to the at least one marketing campaign recommendation includes at least one of a quantity of Facebook likes, new social network followers, campaign shared by customers, customer comments, coupon redemptions, customer purchases, overall campaign statistics, customer preferences, and new sign-ups.

9. The system as recited in claim 1, wherein the output data is obtained from at least one of a website builder application, a website hosting application, and a book-keeping application.

10. The system as recited in claim 1, wherein when the performance metric is above the predetermined threshold value, the processor is configured to assign the marketing campaign recommendations for the business to appropriate marketing channels; and
wherein when the performance metric is below the predetermined threshold value, the processor is configured to not assign marketing campaign recommendations for the business to appropriate marketing channels.

11. A method for automatically analyzing current marketing practices and generating marketing campaign recommendations for a business, the steps of the method comprising:
providing input data configured to be analyzed by a recommendation engine;
assigning the marketing campaign recommendations to at least one marketing channel based on the input data;
launching at least one of the marketing campaign recommendations on the at least one marketing channel;
receiving output data related to the at least one marketing campaign recommendations as consumers are exposed to the at least one marketing campaign recommendations;
calculating a performance metric for the business related to the at least one marketing campaign recommendations;
comparing the performance metric to a predetermined threshold value;
adjusting at least one of the input data, marketing campaign recommendations, and the at least one marketing channel to raise the performance metric toward the predetermined threshold value; and
repeating the above steps until the performance metric is above the predetermined threshold value.

12. The method as recited in claim 11, further comprising the step of receiving at least one of an approval and a disapproval of the marketing campaign recommendations from the business.

13. The method as recited in claim 11, further comprising the step of generating a report for the business, the report including at least one of a portion of the output data and additional marketing campaign recommendations.

14. The method at recited in claim 11, further comprising the step of generating a user interface displaying the marketing campaign recommendations and receiving feedback to at least one of modify the marketing campaign recommendations and generate a new set of marketing campaign recommendations.

15. The method as recited in claim 11, wherein providing input data includes providing at least one of a business type, a business age, a business location, a plurality of business offerings, business preferences, feedback data, business contacts, business news, business branding, related businesses, and business applications.

16. The method as recited in claim 11, further comprising the step of assigning at least one of advertisements and coupons related to the business to the at least one marketing channel, wherein the at least one marketing channel includes at least one of a search engine, a social network, and email.

17. The method as recited in claim 11, wherein receiving output data includes receiving at least one of a quantity of Facebook likes, new social network followers, campaign shared by customers, customer comments, coupon redemptions, customer purchases, overall campaign statistics, customer preferences, and new sign-ups.

18. The method as recited in claim 11, wherein receiving output data includes obtaining the output data from at least one of a website builder application, a website hosting application, and a book-keeping application.

19. The method as recited in claim 11, wherein comparing the performance metric to a predetermined threshold value includes determining that when the performance metric is above the predetermined threshold value, the marketing campaign recommendations for the business are assigned to appropriate marketing channels, and when the performance metric is below the predetermined threshold value, the marketing campaign recommendations for the business are not assigned to appropriate marketing channels.

20. The method as recited in claim 11, further comprising providing a user interface including at least one tool bar for the business to utilize to modify the at least one marketing campaign recommendations.
